(19) United States
(12) Patent Application Publication
(10) Pub. No.: US 2003/0086597 A1
(43) Pub. Date: May 8, 2003

(54) Image processing apparatus, control method of the same, computer program, and storage medium

(76) Inventors: Ken-Ichi Ohta, Kanagawa (JP); Tadayoshi Nakayama, Tokyo (JP); Hidefumi Osawa, Saitama (JP); Shinichi Kato, Kanagawa (JP); Naoki Ito, Tokyo (JP)

Correspondence Address: FITZPATRICK CELLA HARPER & SCINTO, 30 ROCKEFELLER PLAZA, NEW YORK, NY, 10112, US

(21) Appl. No.: 10/284,326

(22) Filed: Oct. 31, 2002

(30) Foreign Application Priority Data
Nov. 2, 2001 (JP) 2001-338333

(51) Int. Cl. G06K 9/00; G06K 9/34

(52) U.S. Cl. 382/131; 382/173

(57) ABSTRACT

This invention does not unconditionally fix the upper limit of encoding but adjusts it in accordance with the size of an input image, thereby effectively utilizing a memory and maintaining high image quality regardless of an image size. In this invention, input image data is compression-encoded by an encoder 102 and stored in first and second memories 104 and 106. An image size detector 111 detects the size of the input image data. An encoding sequence controller 108 determines the upper limit of the code amount of the input image data currently being encoded, and monitors whether this upper limit is exceeded. Upon determining that the upper limit is exceeded, the encoding sequence controller 108 sets encoding parameters of the encoder 102 to set a higher compression ratio, and continues the encoding. Encoded data before this determination is decoded and re-encoded by a re-encoder 109 so as to have a compression ratio higher than before.

### FIELD OF THE INVENTION

The present invention relates to an image processing apparatus for encoding image data, a control method of the same, a computer program, and a storage medium.

### BACKGROUND OF THE INVENTION

Conventionally, a JPEG system using discrete cosine transform and a system using Wavelet transform have been often used as still image compression systems. Since coding systems of this type are variable-length coding systems, the code amount changes from one image to be encoded from another.

In a JPEG system as an international standardized system, only one set of quantization matrices can be defined for an image, so the code amount cannot be adjusted without any prescan. Therefore, when this method is used in a system in which data is stored in a limited memory, memory overflow may occur.

To prevent this, a sufficient memory capacity must be secured. However, the sizes of input images are not unconditionally equal but are different in some cases. Accordingly, it is necessary to secure a memory having a capacity suitable to a maximum possible input size.

Unfortunately, in an apparatus in which a memory is thus secured in accordance with the maximum size, this memory is secured even when images smaller than the maximum size are input. That is, the memory cannot be effectively utilized.

It is, therefore, possible to secure a memory capacity in accordance with medium-sized images. In this case, however, coded data obtained by encoding exceeds this memory capacity.

As countermeasures against this inconvenience, the following methods are known. In one method, if a predetermined code amount is exceeded, the compression ratio is changed, and the original is reread. In another method, a code amount is estimated beforehand by prescan, and quantization parameters are reset to adjust the code amount.

In a conventionally known code amount control method which performs prescan, pre-compressed data is input to an internal buffer memory and expanded, and the expanded data is finally compressed by changing compression parameters and output to an external memory. In this method, the compression ratio of the final compression must be higher than that of the pre-compression.

Unfortunately, this conventional method requires a compression buffer having a target compression ratio or higher. To prevent overflow of an intermediate buffer, therefore, a capacity capable of recording data of original images is necessary.

Furthermore, in a method in which encoding is repetitively performed, decoding and re-compression are performed for all compressed data. This lowers the speed of consecutive processing.

### SUMMARY OF THE INVENTION

The present invention has been made in consideration of the above prior art, and has as its object to provide an image processing apparatus capable of effectively using a memory and maintaining high image quality regardless of an image size, by adjusting the upper limit of encoding in accordance with the size of an input image, instead of unconditionally fixing this upper limit, and to provide a control method of the apparatus, a computer program, and a storage medium.

It is another object of the present invention to provide an image processing apparatus which, even when the upper limit is exceeded during compression encoding of one image, can obviate operations required for re-input and reduce the compression time, by performing the compression encoding while continuously inputting the image, and to provide a control method of the apparatus, a computer program, and a storage medium.

To achieve the above objects, an image processing apparatus of the present invention has the following arrangement.

That is, an image processing apparatus for compression-encoding image data comprises

input means for inputting image data,

detecting means for detecting the size of the input image data from the input means,

setting means for setting a code amount upper limit for compression encoding, in accordance with the detected size of the image data, and

encoding means for encoding the input image data from the input means such that the code amount is equal to or smaller than the code amount upper limit.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram showing the first basic configuration of an image processing apparatus to which the present invention is applied;

FIG. 2 is a block diagram showing the second basic configuration of the image processing apparatus to which the present invention is applied;

FIG. 3 is a flow chart schematically showing processing in the configuration shown in FIG. 1;

FIG. 4 is a view showing a data flow and memory contents in an encoding phase in the initial state;

FIG. 5 is a view showing a data flow and memory contents in an encoding·re-encoding phase;

FIG. 6 is a view showing a data flow and memory contents in a transfer phase;

FIG. 7 is a view showing a data flow and memory contents in an encoding phase after the transfer phase;

FIG. 8 is a flow chart showing details of the processing in the configuration shown in FIG. 1;

FIG. 9 is a view showing a data flow and memory contents in an encoding·re-encoding phase in a modification of the configuration shown in FIG. 1;

FIG. 10 is a view showing a data flow and memory contents in a transfer phase in the modification shown in FIG. 9;

FIG. 11 is a view showing a data flow and memory contents in an encoding phase after the transfer phase in the modification shown in FIG. 9;

FIG. 12 is a flow chart showing a procedure in the configuration shown in FIG. 2;

FIG. 13 is a view showing a data flow and memory contents in an encoding phase in the initial state in the configuration shown in FIG. 2;

FIG. 14 is a view showing a data flow and memory contents in a transfer phase in the configuration shown FIG. 2;

FIG. 15 is a view showing a data flow and memory contents in an encoding·re-encoding phase in the configuration shown FIG. 2;

FIG. 16 is a view showing a data flow and memory contents in an encoding phase after the encoding·re-encoding phase in the configuration shown FIG. 2;

FIG. 17 is a sectional view showing the arrangement of a digital copying machine according to an embodiment;

FIG. 18 is a sectional view showing details of the arrangement of an original reader shown in FIG. 17; and

FIG. 19 is a flow chart showing an operation procedure in FIG. 18.

### DETAILED DESCRIPTION OF THE PREFERRED EMBODIMENTS

Preferred embodiments of the present invention will now be described in detail in accordance with the accompanying drawings. First, basic portions will be explained.

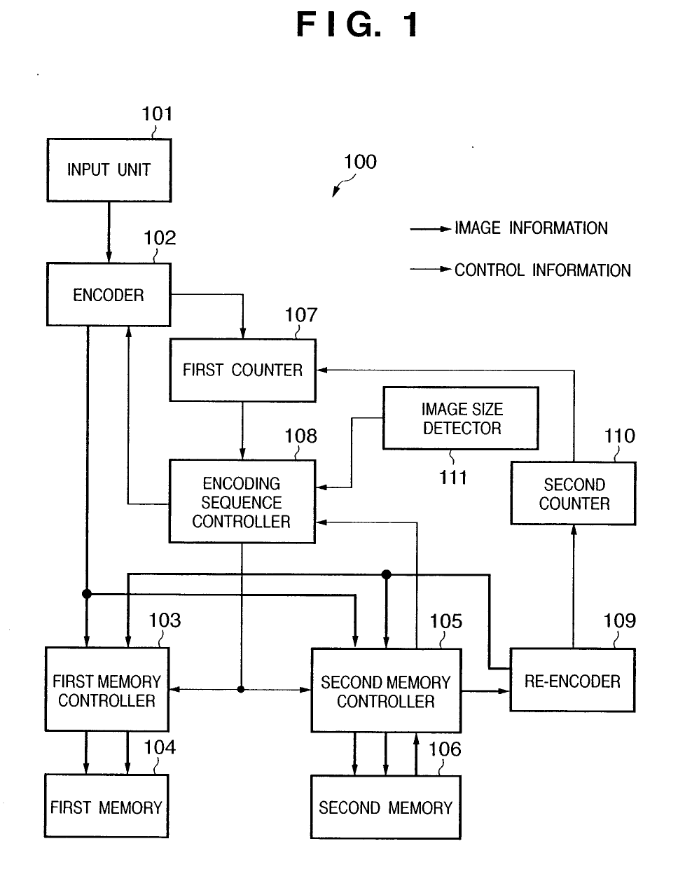

FIG. 1 is a functional block diagram of an image processing apparatus 100 according to an embodiment. Each part will be briefly described below.

This image processing apparatus 100 includes an input unit 101 for inputting images from an image scanner. The input unit 101 can input image data from, e.g., a means for rendering a page description language into a raster image, or can load an image file stored in a storage medium. Images can also be received from a network in some cases.

An encoder 102 encodes input image data. The method of encoding is a well-known JPEG coding system. That is, image data corresponding to a unit of 8×8 pixels is orthogonally transformed, quantized using a quantization step (to be described later), and Huffman-coded.

First and second memory controllers 103 and 105 perform control such that the encoded data (the same encoded data) output from the encoder 102 is stored in first and second memories 104 and 106, respectively. The first memory 104 holds finally determined encoded data (compressed to a data amount within a target value) in order to output the encoded data to, e.g., a network apparatus, image output apparatus, or large-capacity storage device connected outside the basic configuration shown in FIG. 1. The second memory 106 is a work memory which assists compression encoding for forming the encoded data on the first memory.

A counter 107 counts the data amount of image data compression-encoded by the encoder 102 and holds the count value. In accordance with the result of counting, the counter 107 also outputs the count value to an encoding sequence controller 108 for controlling the encoding sequence.

This encoding sequence controller 108 detects whether the count value of the counter 107 has reached a certain set value. Upon detecting that the set value is reached (the target value is exceeded), the encoding sequence controller 108 outputs a control signal to the first memory controller 103 so as to discard data stored in the memory 104. On the basis of this control signal, the first memory controller 103 discards the stored data by clearing a memory address counter or encoded data management table. At the same time, the encoding sequence controller 108 clears the first counter 107 to 0 (while image data is continuously input from the input unit 101), and controls the encoder 102 to encode data at a compression ratio higher than before. That is, the encoding sequence controller 108 so controls the encoder 102 that the data amount of encoded data generated by the encoding process of this apparatus is finally, e.g., 1/2. Note that this data amount can take any arbitrary value although it is set to ½ in this embodiment. Note also that details of setting of the set value (target value) will be explained later, but this value corresponds to an image size detected by an image size detector 111.

Encoded data after the compression ratio is changed is also stored in the first and second memories 104 and 106 via the first and second memory controllers 103 and 105, respectively.

Furthermore, the encoding sequence controller 108 outputs a control signal to the second memory controller 105 to read out encoded data stored in the second memory 106 up to the point and output the readout encoded data to a re-encoder 109 as an encoded data converting means.

The re-encoder 109 decodes the input encoded data, and performs re-quantization and the like for reducing the data amount. After that, the re-encoder 109 outputs to a second counter 110 a data amount obtained by the same compression ratio as the encoder 102 whose compression ratio is changed.

The output encoded data from this re-encoder 109 is stored in the first and second memories 104 and 106 via the first and second memory controllers 103 and 105, respectively.

The second memory controller 105 detects whether the re-encoding process is complete. That is, when there is no more data to be read out and re-encoded, the second memory controller 105 informs the encoding sequence controller 108 that the re-encoding process is complete. In practice, the encoding process is regarded as being complete when not only the read process by the second memory controller 105 but also the processing by the re-encoder 109 is complete.

After the re-encoding processing is completed, the count value obtained by the second counter 110 is added to the count value held in the first counter 107. The result of addition represents the sum of the data amounts in the first memory 104 immediately after the re-encoding process is completed. That is, when the encoder 102 and re-encoder 109 completely encode one frame, the count value held in the first counter 107 after the addition described above represents a total data amount generated when one frame (one page) is encoded by this apparatus (details will be described later).

Regardless of whether the re-encoding process is/is not complete, the encoder 102 keeps encoding image data from the input unit 101 as long as there is data to be encoded.

Whether the count value of the counter 107 has reached the certain set value is repetitively detected until one-page image data input from the input unit 101 is completely coded (encoded and re-encoded). These encoding and re-encoding processes described above are executed under control corresponding to the detection result obtained.

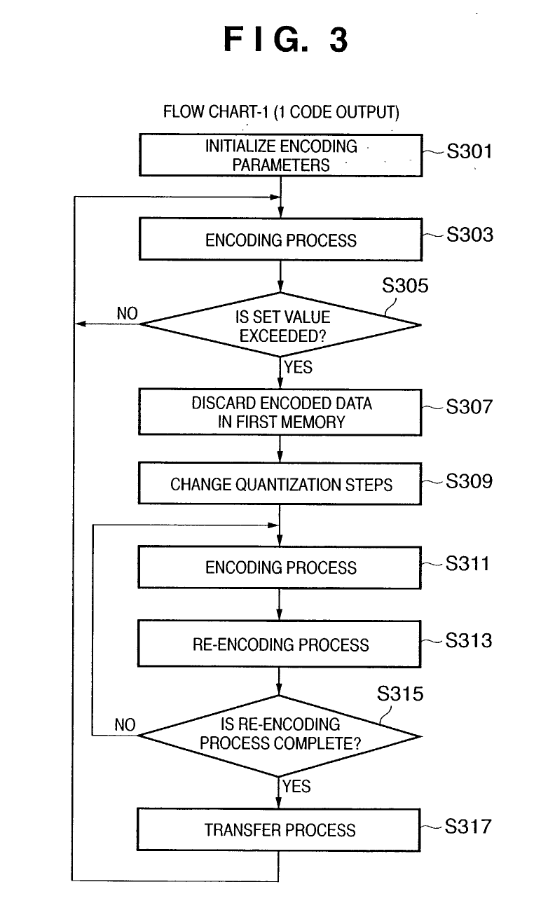

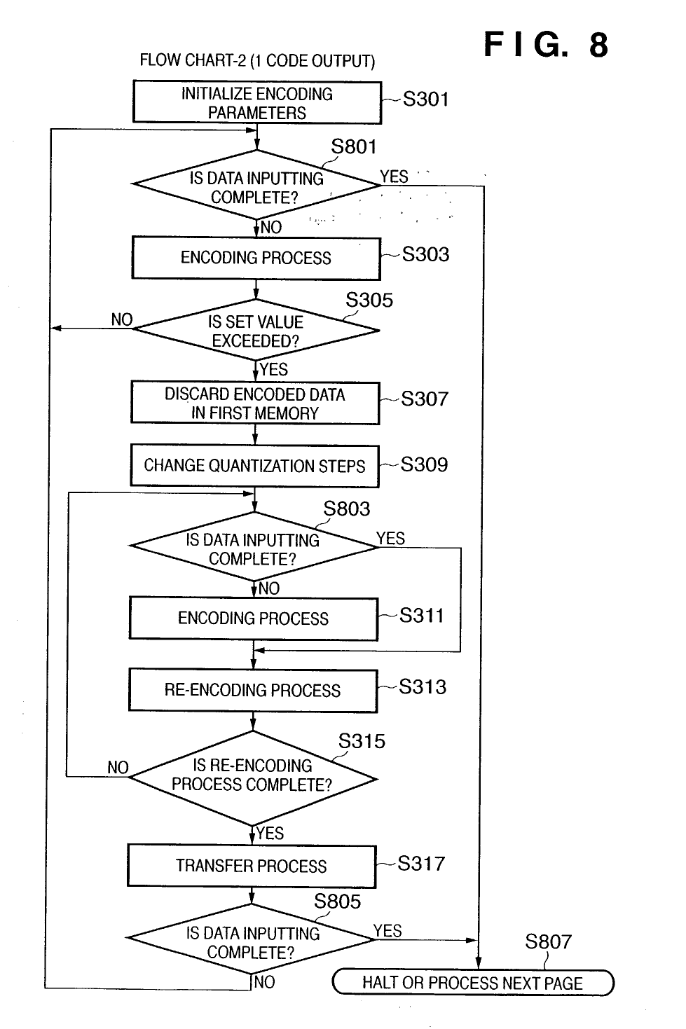

FIG. 8 shows a flow chart representing the flow of processing in the configuration shown in FIG. 1. For descriptive simplicity, however, the processing will be explained first with reference to a simplified flow chart shown in FIG. 3.

As already described above, the image processing apparatus 100 of the present invention compression-encodes one-page image data input from the input unit 101 such as a scanner into a predetermined data amount or smaller. To realize this encoding process, the image processing apparatus 100 includes the encoder 102, re-encoder 109, first and second memories 104 and 106, and the like, in addition to the input unit 101. By using these functional blocks, the image processing apparatus 100 encodes data on the basis of the flow chart shown in FIG. 3.

This flow chart shown in FIG. 3 is roughly divided into three processing phases present below.

(1) Encoding phase

(2) Encoding·re-encoding phase

(3) Transfer phase

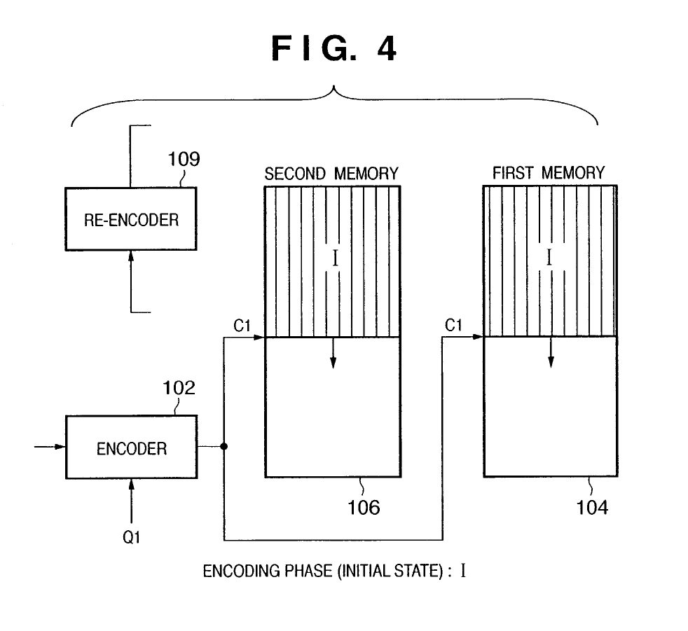

FIGS. 4 to 7 illustrate, in a visually readily understandable manner, the way image data, encoded data, and the like are processed and stored in the memories in the individual processing phases.

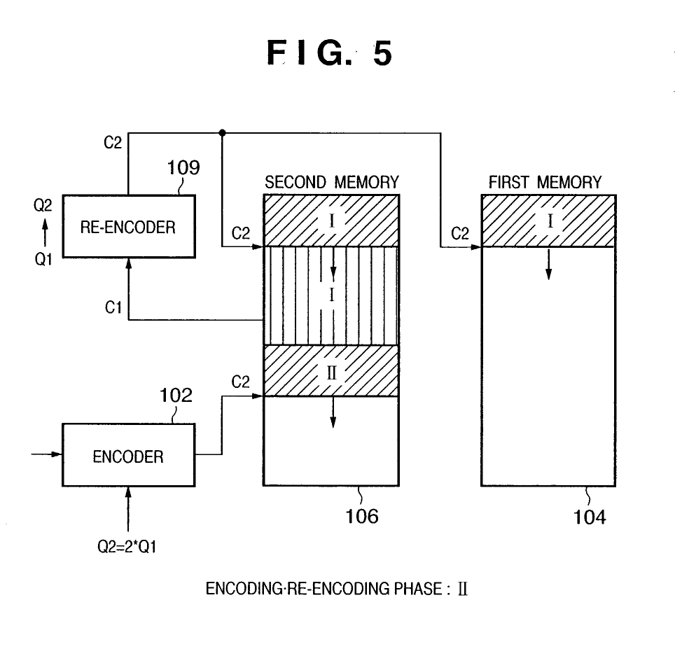

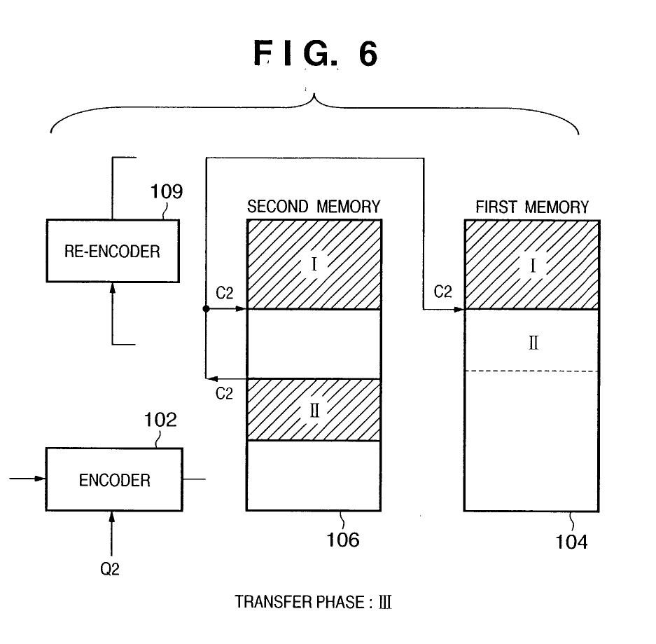

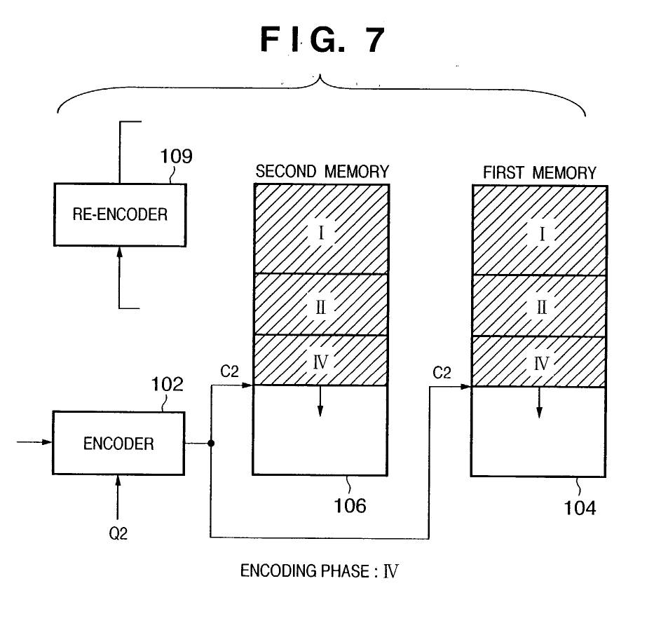

FIG. 4 represents the initial state of the encoding phase corresponding to steps S303 and S305 in the flow chart of FIG. 3. FIG. 5 represents the processing state of the encoding·re-encoding phase corresponding to steps S307 to S315. FIG. 6 represents the processing state of the transfer state corresponding to step S317. FIG. 7 represents the processing state of the encoding phase after the transfer phase. Each phase will be explained below.

<<Encoding Phase>>

Encoding of one-page image data begins with encoding parameter initialization (step S301). Examples of parameters set in this step are the upper limit of an encoded data amount which is uniquely determined from an image size (a paper size read from the input unit 101 such as a scanner) to be encoded, and a quantization step (Ql) to be applied to the encoder 102 (which uses a well-known JPEG coding system in this embodiment).

In step S303, the first counter 107 performs actual encoding (JPEG compression for every 8×8 pixels of the image), and counts the data amount of output encoded data.

In step S305, whether the count value of the data amount has exceeded the aforementioned upper limit is detected. If NO in step S305, the JPEG encoding process in step S303 is continued. This is the initial state encoding phase.

As shown in FIG. 4, the output encoded data from the encoder 102 is stored in both the first and second memories 104 and 106. Regions indicated by the vertical stripes represent the stored codes.

<<Encoding-Re-encoding Phase>>

When the encoding process by the encoder 102 progresses and the count value of the data amount exceeds the set upper limit, the encoded data in the first memory 104 is discarded in step S307, and the quantization step of the encoder 102 is changed to Q2 in step S309.

When the count value of the data amount of encoded data exceeds the set upper limit as described above, the compressed data amount is larger than the target value. In this case, continuing the encoding process by using the same quantization step is meaningless. To make the data amount smaller than before, therefore, the quantization step is changed to Q2 having a quantization step width larger than that of Q1.

After the quantization step is thus changed, in step S311 the encoding process by the encoder 102 is restarted and the encoded data is stored only in the second memory 106 as shown in FIG. 5. In parallel with this processing, re-encoding is performed in step S313. In this re-encoding process, the encoded data stored in the second memory 102 is read out, re-encoded by the re-encoder 109, and stored in the two memories 104 and 106. These encoding process and re-encoding process are continued until codes of vertical stripes I are entirely re-encoded. The output re-encoded data from the re-encoder 109 is exactly the same as encoded data obtained by encoding using the same quantization step as the encoded data output from the encoder 102 after the quantization step is changed.

More specifically, this re-encoding process is realized by performing bit shifting for quantization values after encoded data is once Huffman-decoded, such that the same results as when these values are divided by 2ⁿ are obtained, and performing Huffman encoding again. This method can perform a high-speed re-encoding process since the quantization steps are changed only by bit shifting and neither inverse orthogonal transform nor re-orthogonal transform is performed. In step S315, the completion of the re-encoding process is detected.

The re-encoded data amount is smaller than the data amount of the encoded data before re-encoding. Therefore, as shown in FIG. 5, the re-encoded data can be overwritten in the memory area in which the codes before re-encoding are stored. When this re-encoding processing is complete, the data amount of the encoded data of the vertical stripes I has reduced to the data amount of encoded data of oblique stripes I shown in FIG. 6.

Steps S307 to S315 explained above are processes performed in the encoding·re-encoding phase.

<<Transfer Phase>>

When the re-encoding process is complete, a transfer process is performed in step S317. In this transfer process, as shown in FIG. 6, the encoded data of oblique stripes II stored only in the second memory 106 in the encoding·re-encoding phase is transferred to and stored in an address connected to the encoded data of the oblique lines I in the first memory 104. At the same time, in order that the oblique stripe I encoded data and oblique stripe II encoded data dispersed on the second memory 106 be continuously stored on the first memory 104, the oblique stripe II encoded data is transferred and connected in the second memory 106. This is the processing performed in the transfer phase.

When the above transfer phase is complete, the flow returns to the encoding phase in steps S303 and S305. As shown in FIG. 7, codes of oblique stripes IV are output from the encoder 102 and stored in the two memories 104 and 106. This encoding phase is slightly different from the initial state encoding phase (FIG. 4). That is, the quantization step of encoding by the encoder 102 is changed from Q1 to Q2, and the encoded data stored in the two memories 104 and 106 is a group of codes processed in different phases. When these differences are ignored, the encoding phase immediately after the transfer phase and the initial state encoding phase can be regarded as the same.

Accordingly, by repeating the encoding phase, encoding·re-encoding phase, and transfer phase, codes obtained by compressing one-page image data to the set data amount value or less can be stored in the first memory. In addition, the input unit 101 simply keeps inputting data until the series of processes are completed. This eliminates the need to again input images from the beginning.

To make the explanation readily understandable, the flow chart shown in FIG. 3 describes only the processes corresponding to the phases shown in FIGS. 4, 5, and 6. In practice, however, inputting of one-page image data is completed in one of these phases. Therefore, the subsequent processing slightly changes in accordance with the phase in which the image input is completed. A flow chart in FIG. 8 shows a flow taking this into consideration. This flow chart shown in FIG. 8 takes account of the relationships between the completion of inputting of one-page image data and the various processes explained in FIG. 3. That is, steps S801, S803, S805, and S807 are added to the flow chart in FIG. 3.

In steps S801, S803, and S805, whether inputting of one-page image data from the input unit 101 is complete in the encoding phase, encoding·re-encoding phase, and transfer phase, respectively, is detected.

If it is detected that inputting of the one-page image data is complete in the encoding phase or transfer phase (step S801 or S805), the flow advances to step S807, and compression encoding of that page is terminated. If image data of one or more pages to be processed next is present, compression encoding of the next one-page image data is started. If there is no such data, the operation halts.

On the other hand, if it is detected that inputting of the one-page image data is complete in the encoding·re-encoding phase (step S803), the operation of the encoder 102 must be temporarily stopped until there is no more image data to be re-encoded. Therefore, the encoding process in step S311 is bypassed and, in step S313, only the re-encoding process is continued by which the image data already encoded by the encoder 102 up to the point is reduced to a predetermined encoded data amount. Encoded data of whole one-page image data cannot be collected on the first memory unless the re-encoding process is entirely completed and the subsequent transfer process is completed too. Hence, the re-encoding process and the following transfer process must be continued even after inputting of one-page image data is completed. In this case, if it is detected in step S315 that the re-encoding process is entirely complete, encoded data stored only in the second memory 106 during the encoding·re-encoding phase is transferred to the first memory (step S317). After that, the completion of inputting of one-page image data is detected in step S805, and the flow advances to step S807.

The foregoing is the operation and is also the explanation of the operation shown in FIG. 8.

<Modification of Memory Storage Method>

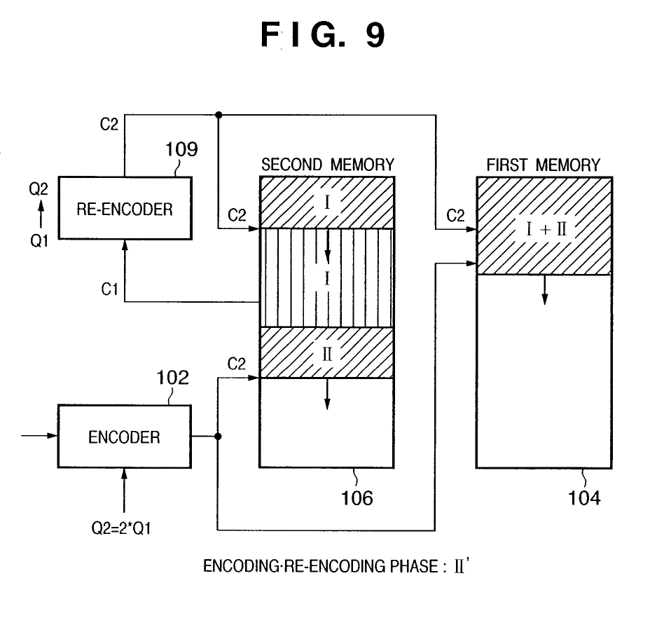

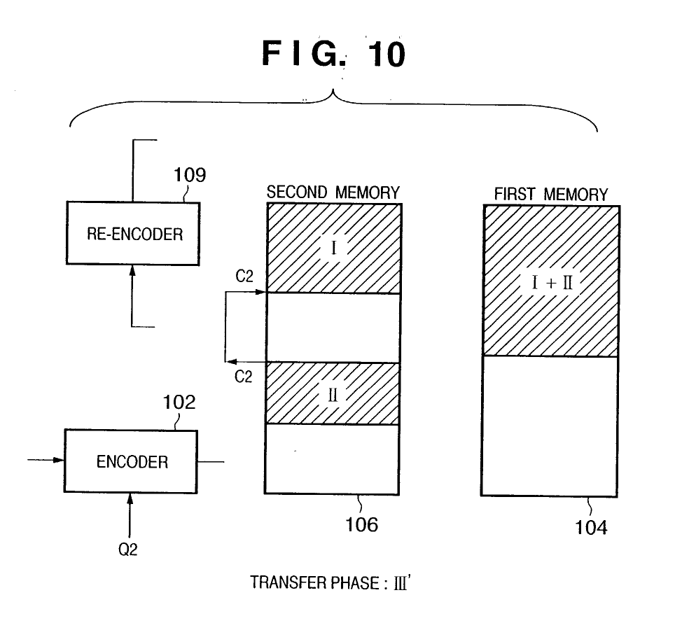

FIGS. 9 and 10 are views showing a modification of the memory storage method shown in the conceptual views of FIGS. 5 and 6.

In the conceptual view of FIG. 5, in the encoding·re-encoding phase the output encoded data from the encoder 102 is stored only in the second memory 106. However, as shown in FIG. 9, the encoded data output from the encoder 102 during the encoding-re-encoding phase is stored directly in both the first and second memories.

From the viewpoint of the encoder 102, data encoded and output in any phase is stored in the two memories. Also, unlike in the conceptual view of FIG. 6, no data transfer between the memories is necessary in the transfer phase as shown in FIG. 10. In this modification, in the encoding·re-encoding phase the encoded data and re-encoded data are sequentially stored in order of transfer to the first memory 104. This poses the problem that two types of data are mixed.

In this modification, therefore, encoded data is divided in certain units and managed as files or packets. More specifically, a file management table or packet management table is separately formed and managed.

As one method, when data from the encoder 102 is stored in the first memory 104, the image data is assigned management numbers from its leading position for every appropriate unit (e.g., for every data of 8×i (i=integer of 1, 2, . . . ) lines since the unit of orthogonal transform is a block of 8×8), and a management table is formed in which the storage start addresses and encoded data amounts of encoded data corresponding to these management numbers can be stored in numerical order.

The encoder 102 and re-encoder 109 hold the management number of data being processed and, on the basis of this management number, write the start address and encoded data amount in the management table when the encoded data is stored. Even when encoded data processed by the encoder 102 and re-encoder 109 are randomly stored, these encoded data can be read out in turn from the leading position of the image by accessing the management table in order of management number and reading out the encoded data from the first memory 104 on the basis of the start addresses to be read out and encoded data amounts. With this management mechanism, data which continues on an image need not be continuously stored on the memory any longer.

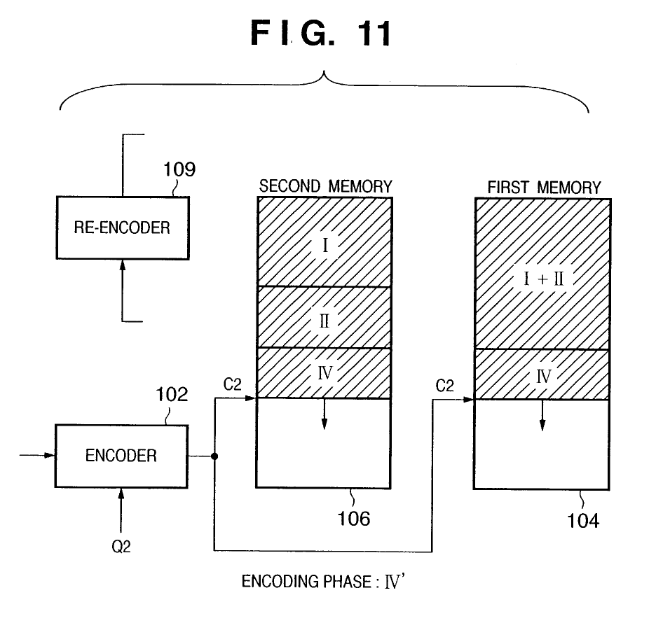

The encoding phase after the transfer phase in the conceptual view of FIG. 10 is substantially the same as the two encoding phases (FIGS. 4 and 7) explained so far, except that the way codes are stored in the first memory is slightly different as shown in FIG. 11. Therefore, the previous explanation and this modification are the same in that the processing is performed by repeating the three phases.

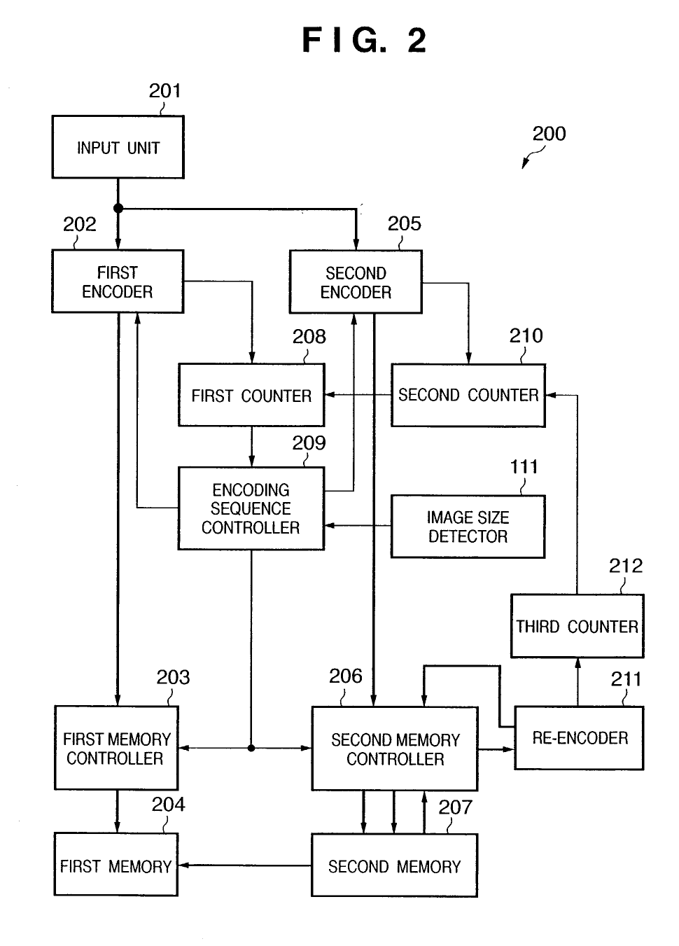

An example of a second basic configuration (the configuration explained above will be referred to as the first example) for performing encoding characterizing the present invention will be described below with reference to FIG. 2.

FIG. 2 is a block diagram of an image processing apparatus according to the second example.

A large difference from the image processing apparatus 100 shown in FIG. 1 is that two parallel encoders perform initial encoding. In this image processing apparatus 200, first and second encoders 202 and 205 encode input image data from an input unit 201 in parallel, thereby generating two types of encoded data different in compression ratio. As in the first example described above, a well-known JPEG coding system is used as the encoding system, and image data corresponding to a unit of 8×8 pixels is orthogonally transformed, quantized using a quantization step (to be described later), and Huffman-coded.

In this example, an operation in which the compression ratio of the second encoder 205 is set to be higher than that of the first encoder 202 will be explained. More specifically, a quantization step in the first encoder 202 is Q1, and a quantization step in the second encoder 205 is Q2 (=2×Q1).

The output encoded data from the encoder 202 is stored in a first memory 204 via a first memory controller 203. A first counter 208 counts the data amount of this output encoded data from the encoder 202, holds the count value, and also outputs the count value to an encoding sequence controller 209.

On the other hand, the data encoded by the encoder 205 is stored in a second memory 207 via a second memory controller 206. A second counter 210 counts the data amount of this output encoded data from the encoder 205, and holds the count value. Furthermore, when the encoded data stored in the second memory 207 is transferred to the first memory 204 (this will be described later), the second counter 210 transfers the count value to the first counter 208.

If the count value has reached a certain set value while the first counter 208 is counting the data amount of the output encoded data from the encoder 202, as in the first example, the encoding sequence controller 209 outputs a control signal to the memory controller 203 to discard the data stored in the memory 204.

The encoding sequence controller 209 then outputs control signals to the memory controllers 206 and 203 to read out the encoded data stored in the second memory 207, transfer the readout data to the first memory 204, and store the data in the first memory 204. As a consequence, the count value of the second counter 210 is transferred to the first counter 208 and loaded (overwritten) as the count value of this first counter 208.

In short, the count value of the second counter 210 represents the data amount of the encoded data stored in the second memory 207. So, this count value and the encoded data are regarded as being directly copied to the first counter and first memory, respectively, such that the correspondence between them remains unchanged.

Furthermore, the encoding sequence controller 209 outputs control signals to the first and second encoders 202 and 205 to encode data such that the encoded data amounts become smaller than before.

For example, the quantization steps in the first and second encoders 202 and 205 are switched to double values. Consequently, the first encoder 202 takes over the quantization step Q2 (=2×Q1) in the second encoder 205 immediately before the switching. Also, the second encoder 205 uses a larger quantization step Q2×2 to encode with a higher compression ratio preparing for the next overflow.

Although the magnification ratio of the quantization step is doubled in this example, it can also be set to any arbitrary value. Encoded data output from the encoders 202 and 205 whose quantization steps are thus changed is stored in the corresponding memories 204 and 207 via the corresponding memory controllers 203 and 206, respectively.

The encoding sequence controller 209 outputs a control signal to the memory controller 206 to read out the encoded data already stored in the second memory and transfer the readout data to a re-encoder 211. This re-encoder 211 re-encodes the encoded data in the same manner as the re-encoder 109 shown in FIG. 1.

A third counter 212 counts the output data amount from the re-encoder 211. That is, this third counter 212 is reset immediately before the start of re-encoding and counts the output data amount during the re-encoding process. When this re-encoding process is complete, the counter 212 transfers the obtained count value to the second counter 210.

The second counter 210 adds the transferred data amount count value to the count value held in this second counter 210, thereby calculating the total data amount of the encoded data and re-encoded data stored in the memory 207 during the re-encoding process. That is, the data amount stored in the memory 207 matches the count value of the counter 210.

Regardless of whether the re-encoding process is/is not complete, the encoding process by the two encoders 202 and 205 is continued as long as image data to be encoded is input from the input unit 201. Whether the count value of the counter 208 has reached the certain set value is repetitively monitored until coding (encoding and re-encoding) of one-page image data input from the input unit 201 is completed. The encoding process and re-encoding process described above are executed under control corresponding to the detection result obtained.

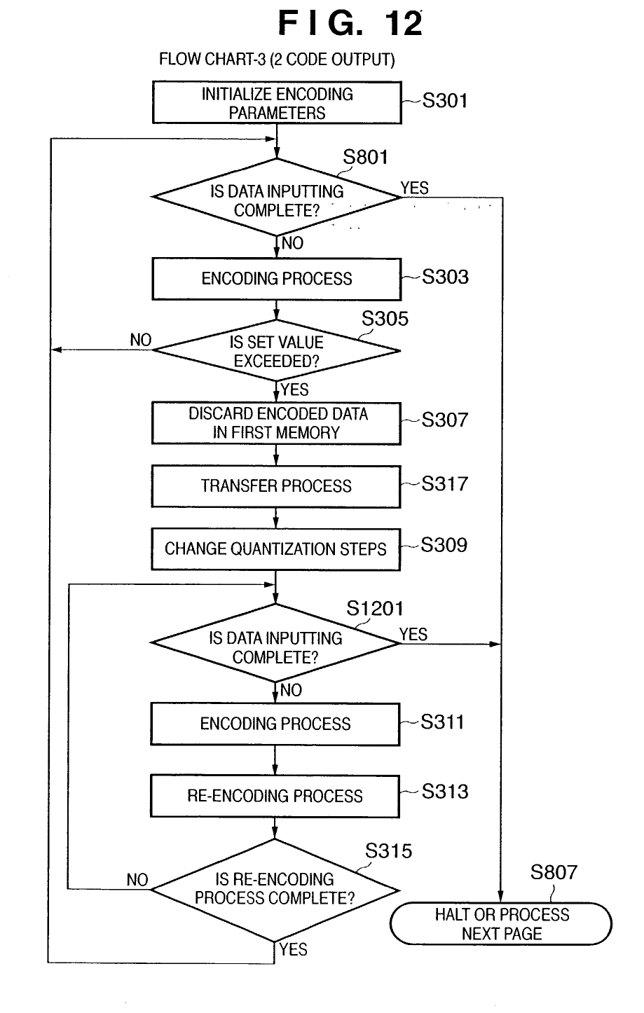

FIG. 12 is a flow chart showing the flow of processing in the configuration shown in FIG. 2.

When two encoders are used as explained in FIG. 2, one-page image data is encoded on the basis of the flow chart shown in FIG. 12. Note that the explanation of FIG. 12 is generally analogous to FIG. 8 which is a flow chart when one encoder is used, so those skilled in the art can well understand the characteristic of this second example from the above explanation. Therefore, the processing will be described by three phases as when one encoder is used, and differences from FIG. 8 will be principally explained.

The biggest difference between the above-mentioned flow shown in FIG. 8 and the flow of this example is that the transfer process in step S317 is inserted between steps S307 and S309. In other words, the encoding·re-encoding phase and transfer phase are switched (except for the encoded data discarding process in step S307).

In encoding parameter initialization in step S301, the quantization step Q1 is set in the first encoder 202, and the quantization step Q2 (=2×Q1) is set in the second encoder 205.

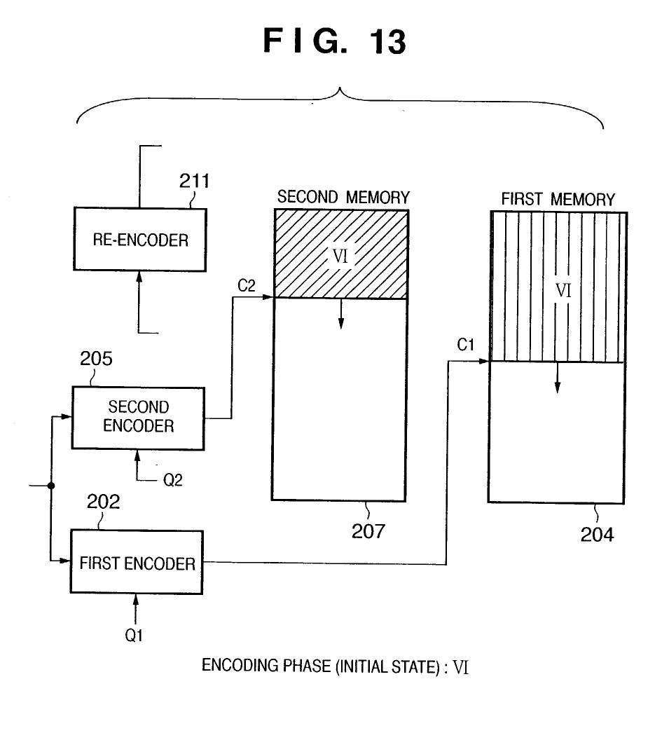

In the encoding phase, steps S801, S303, and S305 are repetitively executed. Steps S801 and S305 are the same processes as when one encoder is used. Only the encoding process in step S303 is different as shown in FIG. 13.

To gradually raise the compression ratio of encoded data to be stored in the first memory 204, data encoded by the quantization step Q1 having the lowest compression ratio is stored first, and data encoded by the quantization step Q2 is stored in the second memory.

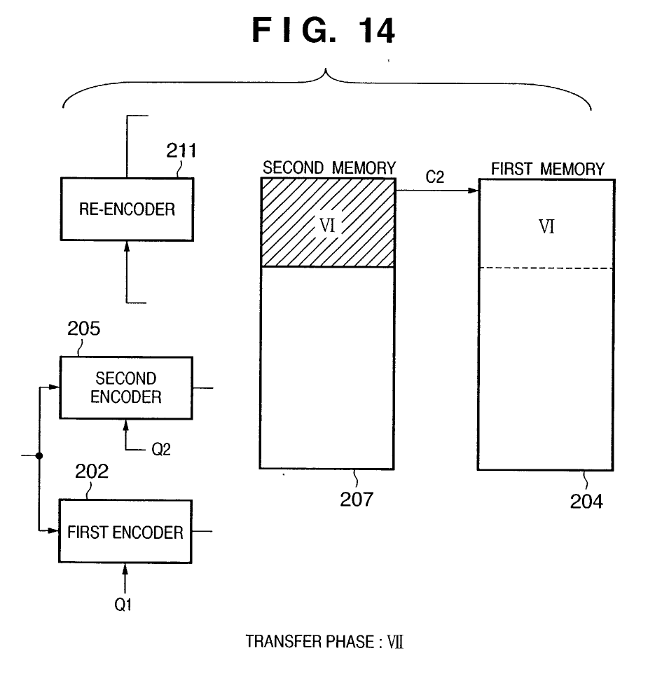

If the data amount being stored in the first memory 204 exceeds a set upper limit (step S305), the encoded data held in this first memory 204 is immediately discarded (step S307), and the encoded data with the high compression ratio held in the second memory 207 is transferred to the first memory 204 (step S317 in FIG. 14). Consequently, encoded data as a second appropriate candidate which does not exceed the upper limit can be immediately stored in the first memory 204 before the completion of the first re-encoding process explained in the first example (FIG. 1). This is the greatest advantage which the application of FIG. 2 using the two encoders has over FIG. 1.

In this second example, it is considered useless to have encoded data with the same compression ratio in the two memories 204 and 207. Therefore, the second memory 207 stores encoded data having a compression ratio higher than that of encoded data stored in the first memory 204. Accordingly, the subsequent processing is performed on the basis of this consideration. That is, after the process (transfer phase) of transferring the encoded data in the second memory 207 to the first memory 204 is completed, the encoded data in the second memory 207 is re-encoded so as to hold encoded data having a compression ratio higher by one step.

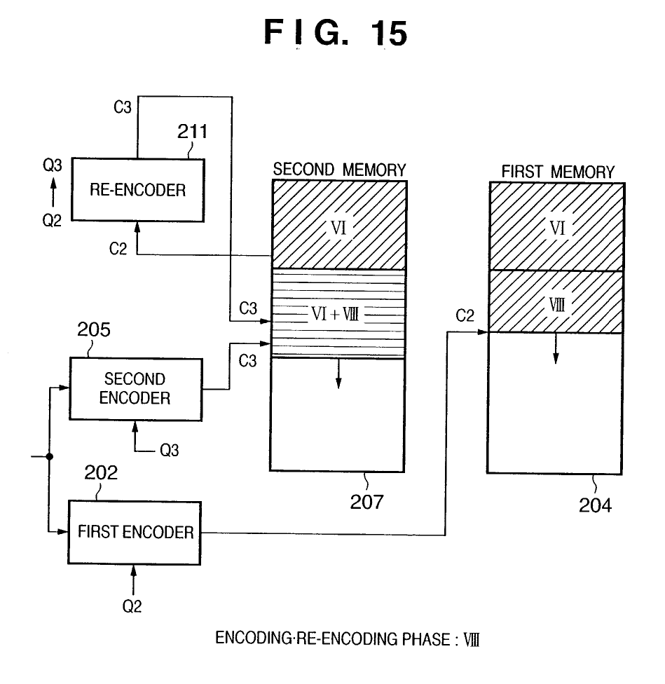

More specifically, as shown in FIG. 15, in the encoding·re-encoding phase following the transfer phase, the quantization steps Q1 and Q2 applied to the two encoders 202 and 205 are changed to Q2 and Q3, respectively, before re-encoding described above is performed (step S309). If inputting of one-page image data is not complete (step S803), subsequent input image data is encoded by the two encoders for which the new quantization steps are set (step S311), and stored in the corresponding memories 204 and 207. In parallel with this encoding process, the encoded data (transferred to the first memory 204) stored in the second memory is re-encoded by the re-encoder 211 to obtain data encoded by using the quantization step Q3 (S313), so that this encoded data is changed to encoded data having the compression ratio higher by one step than the encoded data in the first memory. The re-encoded data is stored in the second memory 207.

As in the first example, this re-encoding process is realized by performing bit shifting for quantization values after encoded data is once Huffman-decoded, such that the same results as when these values are divided by 2ⁿ are obtained, and performing Huffman coding again. This method can perform a high-speed re-encoding process since quantization steps are changed only by bit shifting and neither inverse orthogonal transform nor re-orthogonal transform is performed.

When two encoders are used as in this second example, as shown in FIG. 15, both encoded data and re-encoded data are mixedly stored in the second memory 207. As described previously, therefore, encoded data in this second memory 207 must also be divided in certain units and managed as files or packets. For this purpose, the same arrangement as in the modification of the first embodiment can be used.

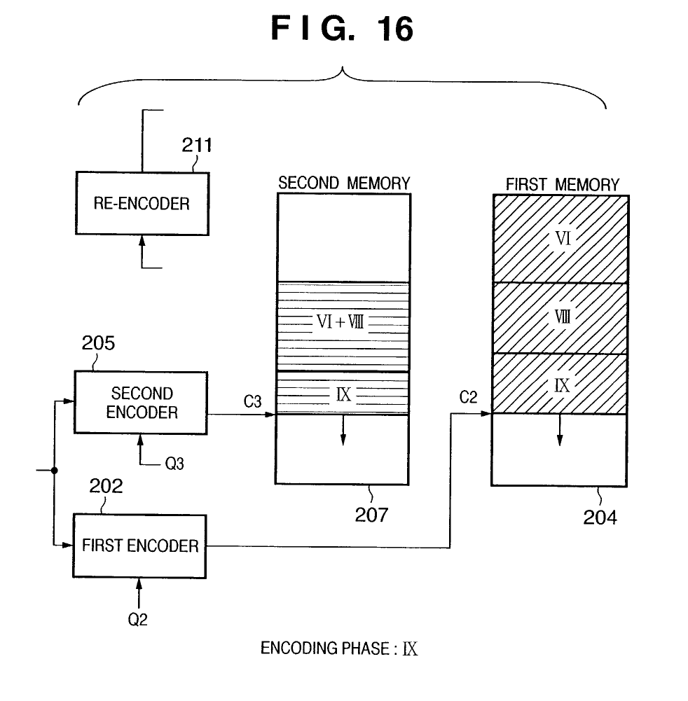

Referring to FIG. 12, if the completion of the re-encoding process is detected in step S315, the flow proceeds to the encoding phase (steps S801 and S303). In this encoding phase after the encoding·re-encoding phase, as shown in FIG. 16, the encoded data held in the two memories 204 and 207 are different not only in compression ratio but also in way (address) these encoded data are mixed. Accordingly, if the data amount in the first memory 204 exceeds the set value again, the encoded data (codes of a lateral-stripe region VI+VIII) held in the second memory 207 must be transferred to the first memory 204. When these are taken into consideration, encoded data must be managed as files or packets in the first memory 204, as well as in the second memory 207. Hence, the first memory 204 also requires a managing mechanism using the management table described earlier.

The state of the encoding phase shown in FIG. 16 is the same as the initial state encoding phase (FIG. 13) except that the quantization steps and the way the encoded data are mixed before re-encoding are different from those after re-encoding. Accordingly, by repeating the encoding phase, transfer phase, and encoding·re-encoding phase, encoded data obtained by compressing one-page image data to the set upper limit or smaller can be reliably stored in the first memory 204.

Note that the positions of the transfer phase and encoding·re-encoding phase are switched from those in the explanation of the first example. Therefore, the timing at which the completion of inputting of one-page image data is detected after the transfer process in FIG. 8 (step S805) is substantially the same as the timing at which the completion of inputting of one-page image data is detected in the encoding·re-encoding phase (step S803). Also, these two detection processes are the same in function as step S805, and the same in timing as step S803. Accordingly, these two steps are integrated as a step of detecting the completion of inputting of new one-page image data, and are represented as step S1201.

In the above first and second examples, the first and second memories are explained as physically different memories. This is advantageous because accesses to these two memories can be independent, and this characterizes the present invention. However, the present invention also includes a case in which the first and second memories are not physically different memories. That is, on a physically single memory, two areas corresponding to the first and second memories are secured. When the explanation so far is reread by rephrasing the first and second memories with first and second memory areas, respectively, it will be understood that the present invention can also be realized with a single memory.

When each of the above examples is to be implemented by a single memory, some data transfer processes explained in the transfer phase are unnecessary. The details will be omitted because each case is readily imaginable. When the two memory areas are to be used as they are strictly separated, it is necessary to perform the same data transfer as when two physically different memories are used. However, if the same data is shared by these two areas, it is possible not only to make the data transfer process unnecessary but also to reduce the storage capacity.

For example, when encoded data held in the second memory area is to be transferred to the first memory area, two pieces of information, i.e., the start address in which the encoded data is stored and the data size need only be transferred from the second memory controller to the first memory controller. This achieves the same effect as when the encoded data is transferred.

When the encoded data is stored in the form of a file or packet, the amount of information transferred between the memory controllers slightly increases, so management table information related to the encoded data must be transferred. Still, the efficiency is higher than that when the encoded data is transferred.

<<Setting of Conditions of Transfer to Re-encoding Phase>>

In the first example and its modification and in the second example, the encoding sequence controller 108 or 209 monitors the code amount generated for image data currently being input, checks whether the code amount has exceeded a set value (target value) (e.g., S305 in FIG. 3), and controls encoding-related processing accordingly.

This set value, i.e., the upper limit, is determined by referring to the size of an input image. Hence, the image size detector 111 is included in FIGS. 1 and 2. Note that the memory size of the first and second memories 104 and 106 shown in FIG. 1 is finite, so the upper limit for phase shifting must be so set that this memory size is not exceeded.

In a JPEG compression system as explained in the embodiment, however, the compression ratio (i.e., the compressed data volume) changes in accordance with the contents of an input image. Therefore, if the upper limit is lowered, the memory capacity can be reduced, but the probability of shifting to the re-encoding phase increases depending on an input image.

Shifting to the re-encoding phase roughens the quantization step of compression and deteriorates the image quality. That is, it is unpreferable to set the upper limit to be lower than necessary.

Input images from the input unit can have various sizes. For example, an input image from a flat bed scanner can be an image obtained by quantizing a maximum of A3 size (297×420 mm) by 600 dpi in the main scan and sub-scan directions, or by quantizing a region of a minimum of a name card size, or can be an image read at a low resolution of about 100×200 dpi, not at 600 dpi. That is, the input image size variously changes in accordance with these conditions.

When the input image size changes, the compression data volume generated by JPEG compression also changes accordingly. Therefore, it is unwise to always set the same upper limit to check shifting to re-encoding.

The size of an input image from the input unit is determined by the number of pixels (Px) in the main scan direction, the number of pixels (Py) in the sub-scan direction, and the number of color planes (Pz).

The compressed data volume is substantially proportional to the volume of input image data. Therefore, the upper limit for shifting to re-encoding is desirably set in proportion to the value of M which is represented by

M=Px×Py×Pz

This value of M corresponds to the total number of pixels of an input image.

For example, assuming that A3-size image data is read at a resolution of 600 dpi by RGB colors,

Px=7,000

Py=9,920

Pz=3

So, the total number of pixels M=208,320,000.

If the volume is 1 byte per 1 pixel and 1 color component, the total volume is about 200 MBytes. Assuming that the compression ratio for a standard image is about 1/10, the average compressed volume is about 20 MBytes, so the upper limit for shifting to re-encoding is set to 20 MBytes. If a maximum image size which can be input to this system is A3 with 600 dpi, the capacity of the first and second memories (104 and 106) installed must be, of course, a minimum of 20 MBytes.

Assuming that A4-size image data is input at a resolution of 200 dpi by RGB colors,

Px=2,340

Py=1,650

Pz=3

So, M=11,583,000. If 1 byte is used per 1 pixel and 1 color component as described above, the total volume is about 11 MBytes. If the compression ratio is similarly 1/10, the average compressed volume is about 1.1 MB, so the upper limit for shifting to re-encoding is set to 1.1 MB.

As described above, the installed memory capacity is 20 MBytes in accordance with the maximum image size. Therefore, the upper limit can always be set at 20 MBytes regardless of the size of an input image. However, if a memory area of 20 MB is always secured although the input image size is small (the compressed data volume is also naturally small), resources cannot be effectively utilized. That is, when an input image is small, an unnecessary memory area can be allocated to other tasks.

Also, when the upper limit is varied in accordance with the input image size, a plurality of pages can be simultaneously stored on a memory. For example, when processing such as image input→compression→transfer to an auxiliary storage device is continuously performed for a plurality of input pages, before immediately preceding image data is transferred to the low-speed auxiliary storage device the next input image can be processed. This improves the performance of image input.

In the above explanation, the re-encoding upper limit is determined in proportion to the input image size. If the image size is small, however, the compressed image size (the code amount after compression encoding) is smaller than the real memory size, so an upper limit having a certain margin can be set. Accordingly, letting Mmax be the M value of a possible maximum input image, M be the M value of an actual image used, and 1/R be the average compression ratio, the upper limit can also be set by

Upper limit (bytes)=(M/Mmax+α)×(Mmax/R)

α is a correction parameter for setting a value larger than the upper limit of compressed data estimated from the input image size. α is desirably about 0.2.

Mmax is a fixed value because it is determined by the maximum read size of a scanner. M is determined in accordance with image size information detected by the image size detector 111 shown in FIGS. 1 and 2.

<Practical Explanation>

A practical embodiment of the examples described so far, a digital copying machine to which the present invention is applied will be explained below.

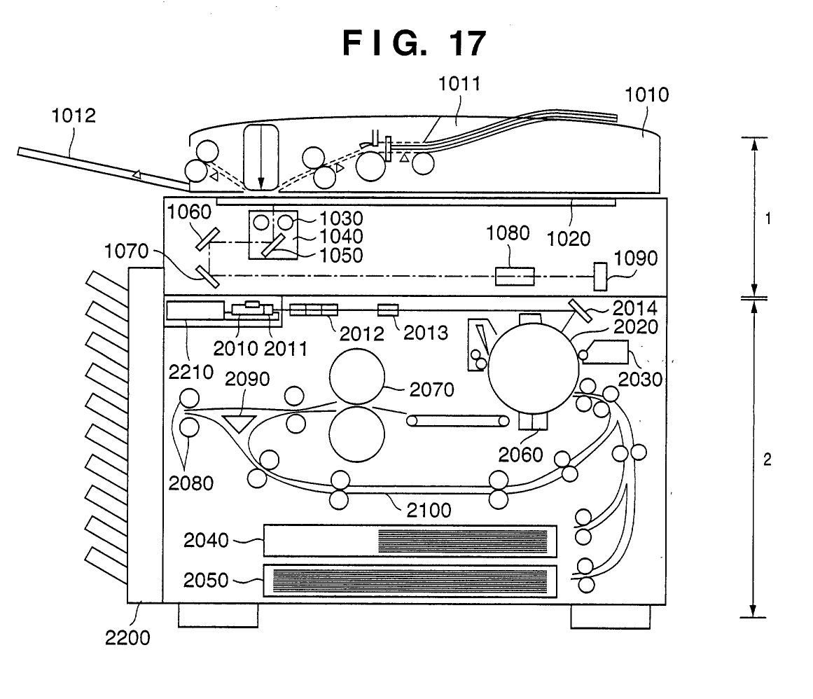

FIG. 17 shows the arrangement of a digital copying machine according to the embodiment. That is, FIG. 17 is a sectional view of a reader unit 1 and printer unit 2. The reader unit 1 corresponds to the input unit 101 in FIG. 1 (201 in FIG. 2).

An automatic document feeder 1010 of this reader unit 1 feeds originals set on an original table one by one from the final page onto platen glass 1020. After each original is read, the automatic document feeder 1010 delivers the original on the platen glass 1020 to a paper receiving tray. When an original is conveyed onto the platen glass 1020, a lamp 1030 is turned on, and a scanner unit 1040 starts moving to expose the original by scan. The reflected light from the original is guided to a CCD image sensor (to be referred to as a CCD hereinafter) 1090 by mirrors 1050, 1060, and 1070 and a lens 1080. An image of the original thus scanned is read by the CCD 1090. The output image data from this CCD 1090 is loaded into a controller 2210 comprising circuits corresponding to the configuration shown in FIG. 1. The image data is compressed and temporarily stored in an internal memory (the first memory 204 in FIG. 1).

While this storage process is performed, images are decoded from the one which is compressed earliest, and subjected to binarization or PWM processing following the known procedure. The obtained signal is supplied to a laser driver 2010, thereby driving a laser beam emitter 2011 to emit a laser beam corresponding to the image.

This laser beam exposes a photosensitive drum 2020 by scan via a rotary polygonal mirror 2012, lens 2013 having the f-θ characteristic, and mirror 2014. In this manner, an electrostatic latent image corresponding to the laser beam is formed on the surface of the photosensitive drum 2020. A developing device 2030 adheres a developer to this latent image on the photosensitive drum 2020. In synchronism with the start of emission of the laser beam, a printing sheet is conveyed from one of cassettes 2040 and 2050 to a transfer unit 2060, and the developer (toner) adhered to the photosensitive drum 2020 is transferred onto this printing sheet. The printing sheet thus having the developer on it is conveyed to a fixing unit 2070, and the developer is fixed on the printing sheet by heat and pressure of the fixing unit 2070. This printing sheet from the fixing unit 2070 is discharged by discharge rollers 2080. A sorter 2200 stores each discharged printing sheet into a corresponding bin, thereby sorting printing sheets. If no sorting is set, the sorter 2200 stores printing sheets in the uppermost bin. If double-sided recording is set, after a printing sheet is conveyed to the discharge rollers 2080, the rotational directions of these discharge rollers 2080 are reversed, and a flapper 2090 guides the printing sheet to a paper re-feed convey path. If multiple recording is set, a printing sheet is guided to the paper re-feed convey path by the flapper 2090 before being conveyed to the paper discharge rollers 2080. The printing sheet thus guided to the paper re-feed convey path is fed to the transfer unit 2060 at the above-mentioned timing.

Although FIG. 17 shows the arrangement of a black-and-white copying machine, a similar arrangement is applicable even to a color copying machine.

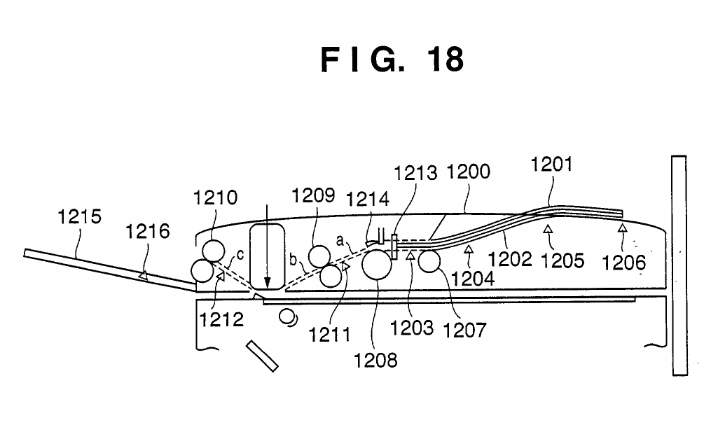

FIG. 18 is a sectional view showing details of the automatic document feeder 1010.

Referring to FIG. 18, an automatic document feeder (ADF) 1200 is the same as 1010 in FIG. 17, and has an original table 1202 on which originals 1201 are set.

This original table 1202 includes a portion of a sheet feeding means and also has an original sensor 1203 and first, second, and third original size sensors 1204, 1205, and 1206 (each of which senses, e.g., the paper size of an original) in the longitudinal direction of original conveyance.

This sheet feeding means comprises a conveyor roller 1207, separation roller 1208, separation·conveyor motor (not shown), registration rollers 1209, sheet delivery rollers 1210, registration sensor 1211, sheet delivery sensor 1212, shutter 1213, and weight 1214. When a shutter solenoid (not shown) is pulled, the shutter 1213 is raised and the weight 1214 is lowered. The separation·conveyor motor (not shown) is rotated forward to drive the conveyor roller 1207 and separation roller 1208, thereby separating the lowermost original from the originals 1201 on the original table 1202.

Also, when this separation·conveyor motor is rotated backward to drive the registration rollers 1209 and sheet delivery rollers 1210, an original on a sheet path a is conveyed and read the exposure·read position through a sheet path b, conveyed to a sheet path c, and delivered onto a sheet receiving tray 1215 by the sheet delivery rollers 1210. A sheet sensor 1216 senses the presence/absence of a sheet on the sheet receiving tray 1215.

In the above arrangement, the image size detector 111 shown in FIGS. 1 and 2 detects the size of an image to be input (read) on the basis of signals from the sensors for sensing the original size. This image size is determined on the basis of the size of an input original and the read resolution. Since the read resolution is regarded as being fixed in the above arrangement, the input image size is dominated by an input original size after all.

The operation of the above configuration will be described below.

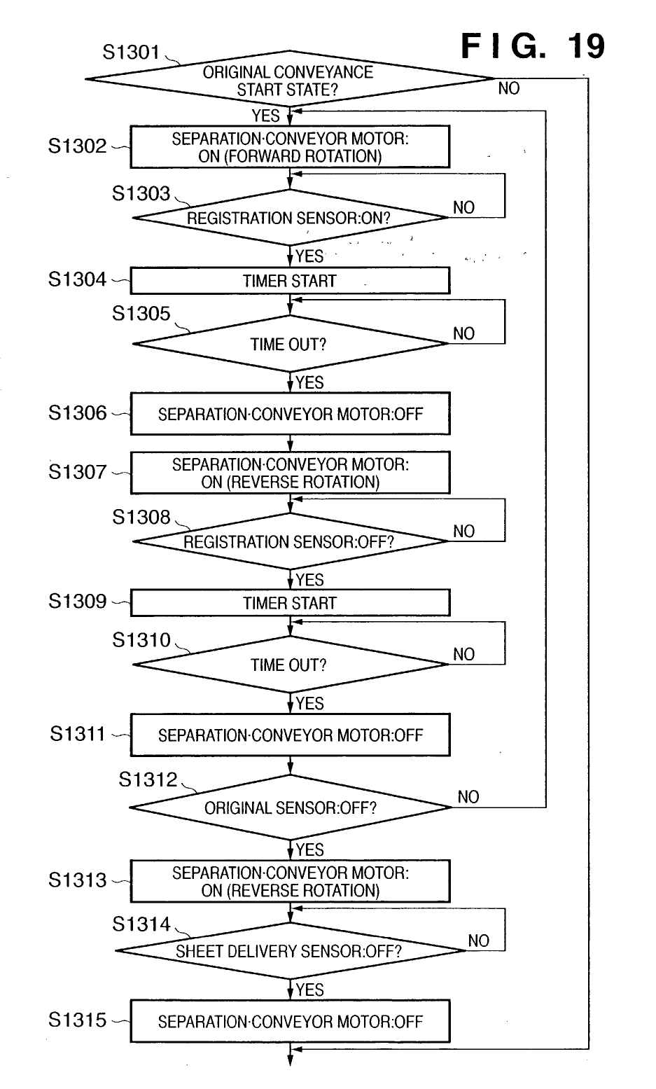

FIG. 19 is a flow chart showing the operation sequence of the automatic document feeder (ADF) 1200 according to the embodiment.

When receiving an original conveyance start signal transmitted for the first one of the originals 1201 from an internal CPU of the controller 2210, the ADF 1200 checks in step S1301 whether original conveyance can be started. If original conveyance cannot be started, the flow skips to step S1315 to terminate the operation without performing any original conveyance.

If it is determined in step S1301 that original conveyance can be started, the shutter 1213 in FIG. 18 is raised, the weight 1214 is lowered, and the separation·conveyor motor is rotated forward (step S1302), thereby driving the conveyor roller 1207 and separation roller 1208 to start separating the originals 1201. In this state, the registration rollers 1209 and sheet delivery rollers 1210 are not driven. Whether the registration sensor 1211 senses the leading edge of the separated original is checked on the basis of a signal from this registration sensor 1211 (step S1303). If YES in step S1303, a timer is started so that the motor stops when the original is pushed against the registration rollers 1209, in order to remove any skew of the original (step S1304). When this timer times out (step S1305), the separation·conveyor motor is stopped (step S1306), and the operation of separation is completed.

Next, the rotational direction of the separation·conveyor motor is reversed to stop driving of the conveyor roller 1207 and separation roller 1208 and drive the registration rollers 1209 and sheet delivery rollers 1210, thereby starting conveying the original pushed against the registration rollers 1209 (step S1307). This original is read as it is conveyed on the optical system fixing position of the main body. Whether the registration sensor 1211 senses the trailing edge of the original is checked on the basis of a signal from this registration sensor 1211 (step S1308). If YES in step S1308, the timer is started so that the motor stops when the trailing edge of the original passes by the read position (step S1309). When this timer times out (step S1310), the separation·conveyor motor is stopped (step S1311), and the read operation is completed.

Whether the next original is present is checked on the basis of a signal from the original sensor 1203 (step S1312). If it is determined that the next original is present, the flow returns to step S1302. When steps up to step S1306 are performed for this next original to be read, the operation of separating the next original is completed. Since neither the registration rollers 1209 nor sheet delivery rollers 1210 are driven during this operation, the read original is held with its trailing edge placed in the read position.

The flow advances to step S1307, and steps up to step S1311 are performed. After that, the separation·conveyor motor is rotated backward to drive the registration rollers 1209 and sheet delivery rollers 1210 to read the next original. At the same time, the read original is delivered onto the sheet receiving tray 1215. If in step S1312 the original sensor 1203 senses no next original, it is determined that the read original is the last one of the originals 1201. Therefore, the flow advances to step S1313 without separating any next original, the separation·conveyor motor is rotated backward to drive the sheet delivery rollers 1210, thereby starting delivering the last original.

At the start of the operation, the original is nipped by the sheet delivery rollers 1210, so the sheet delivery sensor 1212 positioned near these sheet delivery rollers 1210 senses this original. In step S1314, therefore, the sheet delivery sensor 1212 senses the trailing edge of the original. If this trailing edge is sensed, the motor is driven such that the trailing edge of the original passes by the sheet delivery rollers 1210, and the separation·conveyor motor is stopped (step S1315).

In this above arrangement, the first, second, and third original size sensors 1204, 1205, and 1206 can sense the size of an original placed on the document feeder in advance. That is, each sensor can sense whether an original sheet is present on the upper surface of the sensor. For example, if the sensor 1204 senses a sheet of paper and the sensors 1205 and 1206 do not, it is determined that a small-size sheet which is A4 size or smaller is placed. If all the three sensors sense a sheet of paper, it is determined that a large-size sheet which is A3 size or larger is placed.

By referring to this original size information, the internal CPU of the controller 2210 can set the upper limit for shifting to re-encoding.

As described previously, when an A3-size original is sensed, the upper limit is set to 20 MBytes. When an original which is A4 size or smaller is sensed, a capacity half that for an A3-size original is satisfactory. Therefore, the upper limit can be set to 10 MBytes.

In the above explanation, the original size is discriminated on the basis of sensor information from the sheet size sensors of the document feeder. However, it is, of course, also possible to use a well-known original size sensing mechanism installed in a scanner main body, when an original is directly placed on an original glass plate, or to use a method of sensing the size by prescanning an original image.

Also, the examples of the embodiment are applied to a copying machine. However, in a printer which prints on the basis of printing data from a host computer, for example, an image size generated by rendering the printing data can be detected by detecting information concerning a printing sheet size contained in the printing data. Accordingly, the present invention is not restricted to a copying machine as described above. Furthermore, it will be readily understood that an image input portion is not limited to an image scanner.

The present invention is also applicable to a system comprising an image input means (e.g., an image scanner or a drive which reads images from a storage medium such as a floppy disk storing the images), and a general-purpose information processing apparatus such as a personal computer.

That is, the present invention can also be implemented by a computer program. A computer program is normally copied to or installed in a hard disk or the like by setting a storage medium such as a floppy disk or CD-ROM in an apparatus. Hence, the present invention includes such storage media.

As has been explained above, this embodiment comprises the encoding means, quantization step control means, encoded data converting means, storage means, and monitoring means. The encoding means converts the frequency of image data, quantizes the frequency-converted image data, and performs variable-length encoding for the quantized image data. The quantization step control means controls switching between quantization steps used in the quantization. The encoded data converting means is installed independently of the encoding means. This encoded data converting means converts encoded data obtained by the encoding means into another encoded data which is to be obtained by encoding using a quantization step different from the quantization step used to obtain the former encoded data. The storage means stores at least one page of the encoded data obtained by-the encoding means or encoded data converting means. The monitoring means monitors the amount of the encoded data stored in the storage means. In accordance with the size of an input image and the amount of the encoded data, switching between the quantization steps in the quantization step control means and the encoded data converting means are controlled in association with each other. As a consequence, one-page image data is converted into a desired encoded data amount by one encoding process. Accordingly, encoded data can be reliably stored in a memory having a small capacity corresponding to the size of an input image.

In the present invention as has been explained above, the upper limit for encoding is not unconditionally fixed but is adjusted in accordance with the size of an input image. This makes it possible to effectively utilize the memory and maintain high image quality regardless of an image size.

Also, even when the upper limit is exceeded during compression encoding of one image, this compression encoding is performed while image inputting is continued. This obviates the need for operations of re-input and also reduces the time required for compression.

As many apparently widely different embodiments of the present invention can be made without departing from the spirit and scope thereof, it is to be understood that the invention is not limited to the specific embodiments thereof except as defined in the appended claims.

What is claimed is:

1. An image processing apparatus for compression-encoding image data, comprising:
input means for inputting image data;
detecting means for detecting the size of the input image data from said input means;
setting means for setting a code amount upper limit for compression encoding, in accordance with the detected size of the image data; and
encoding means for encoding the input image data from said input means such that the code amount is not more than the code amount upper limit.

2. The apparatus according to claim 1, wherein
the input image from said input means is multi-valued image data, and
said encoding means comprises:
a memory for storing compression-encoded multi-valued image data;
first image compressing means whose parameters for determining a compression ratio can be changed;
second image compressing means whose parameters for determining a compression ratio can be changed, said second image compressing means decoding and re-compressing encoded data compressed by said first image compressing means;
code amount monitoring means for monitoring a code amount generated by said first image compressing means, and checking whether the encoded data amount has reached the code amount upper limit set by said setting means;
image encoding parameter setting means for, if said code amount monitoring means determines that the code amount upper limit is reached, setting parameters for raising the compression ratios in said first and second image compressing means; and
image compression control means for, when the parameters are changed by said image encoding parameter setting means, causing said second image compressing means to re-encode the encoded data previously generated by said first image compressing means, and causing said memory to save the re-encoded data as encoded data after the parameters of said first image compressing means are changed, and
causing said memory to save encoded data generated by said first image compressing means after the parameter change as subsequent encoded data.

3. The apparatus according to claim 2, wherein said image encoding parameter setting means sets a quantization step of encoding.

4. The apparatus according to claim 3, wherein if said image encoding parameter setting means sets the quantization step, said second image compressing means performs decoding in a quantized state, and performs variable-length encoding again by bit shifting.

5. The apparatus according to claim 1, wherein said detecting means detects the total number of pixels of input image data.

6. The apparatus according to claim 5, wherein said detecting means detects the total number of pixels on the basis of the resolution and paper size of an input original.

7. An image processing method of compression-encoding image data, comprising:
the input step of inputting image data;
the detection step of detecting the size of the image data input in the input step;
the setting step of setting a code amount upper limit for compression encoding, in accordance with the detected size of the image data; and
the encoding step of encoding the image data input in the input step such that the code amount is not more than the code amount upper limit.

8. The method according to claim 7, wherein
the image input in the input step is multi-valued image data, and
the encoding step comprises:
the first image compression step whose parameters for determining a compression ratio can be changed, the first image compression step storing compression-encoded data in a predetermined memory;
the second image compression step whose parameters for determining a compression ratio can be changed, the second image compression step decoding and re-compressing encoded data compressed in the first image compression step;
the code amount monitoring step of monitoring a code amount generated in the first image compression step, and checking whether the encoded data amount has reached the code amount upper limit set in the setting step;
the image encoding parameter setting step which, if the code amount monitoring step determines that the code amount upper limit is reached, sets parameters for raising the compression ratios in the first and second image compression steps; and
the image compression control step which, when the parameters are changed by the image encoding parameter setting step, causes the second image compression step to re-encode the encoded data previously generated in the first image compression step, and causes the memory to save the re-encoded data as encoded data after the parameters in the first image compression step are changed, and
causes the memory to save encoded data generated in the first image compression step after the parameter change as subsequent encoded data.

9. A computer program for compression-encoding image data, comprising:
a program code of the input step of inputting image data;
a program code of the detection step of detecting the size of the image data input in the input step;
a program code of the setting step of setting a code amount upper limit for compression encoding, in accordance with the detected size of the image data; and
a program code of the encoding step of encoding the image data input in the input step such that the code amount is not more than the code amount upper limit.

10. The program according to claim 9, wherein
the image input in the input step is multi-valued image data, and
the program code of the encoding step comprises:
a program code of the first image compression step whose parameters for determining a compression ratio can be changed, the first image compression step storing compression-encoded data in a predetermined memory;
a program code of the second image compression step whose parameters for determining a compression ratio can be changed, the second image compression step decoding and re-compressing encoded data compressed in the first image compression step;
a program code of the code amount monitoring step of monitoring a code amount generated in the first image compression step, and checking whether the encoded data amount has reached the code amount upper limit set in the setting step;
a program code of the image encoding parameter setting step which, if the code amount monitoring step determines that the code amount upper limit is reached, sets parameters for raising the compression ratios in the first and second image compression steps; and
a program code of the image compression control step which, when the parameters are changed by the image encoding parameter setting step, causes the second image compression step to re-encode the encoded data previously generated in the first image compression step, and causes the memory to save the re-encoded data as encoded data after the parameters in the first image compression step are changed, and
causes the memory to save encoded data generated in the first image compression step after the parameter change as subsequent encoded data.

11. A computer-readable storage medium storing the computer program defined in claim 9.
